(19) United States
(12) Patent Application Publication
(10) Pub. No.: US 2018/0288502 A1
(43) Pub. Date: Oct. 4, 2018

(54) INFORMATION COLLECTION SYSTEM AND INFORMATION COLLECTION APPARATUS

(71) Applicant: TOYOTA JIDOSHA KABUSHIKI KAISHA, Toyota-shi (JP)

(72) Inventors: Takamasa HIGUCHI, Kawaguchi-shi (JP); Seii SAI, Yokohama-shi (JP); Kenji HORIGUCHI, Tokyo (JP)

(73) Assignee: TOYOTA JIDOSHA KABUSHIKI KAISHA, Toyota-shi (JP)

(21) Appl. No.: 15/915,498

(22) Filed: Mar. 8, 2018

(30) Foreign Application Priority Data
Mar. 28, 2017 (JP) 2017-063431

(51) Int. Cl. H04Q 9/00

(52) U.S. Cl. CPC H04Q 9/00; G07C 5/008; H04Q 2209/40

(57) ABSTRACT

An information collection apparatus collecting data sensed by a plurality of mobile sensors, the information collection apparatus comprises a condition setting unit configured to set a target area and a target time period in which data is to be collected; a position information storage unit configured to acquire and store position information of the mobile sensors; a mobile sensor selection unit configured to select, based on the history of position information of the mobile sensors and the target time period, a plurality of the mobile sensors for collecting a given amount of data sensed in the target area; and a collection unit configured to collect data from the plurality of selected mobile sensors.

### CROSS REFERENCE TO RELATED APPLICATION

This application claims the benefit of Japanese Patent Application No. 2017-063431, filed on Mar. 28, 2017, which is hereby incorporated by reference herein in its entirety.

### BACKGROUND OF THE INVENTION

### Field of the Invention

The present invention relates to a technique for collecting information using a mobile sensor.

### Description of the Related Art

In recent years, the collection and utilization of data from traveling vehicles are being studied. For example, collecting current positions and speed information from a plurality of vehicles, traffic congestion information can be generated in real time. In addition, smoother traffic can be realized by analyzing, from various angles, data collected from

Examples of techniques related thereto include a system described in Japanese Patent. Application Laid-Open No. 2010-140072. In the system, when a vehicle requiring information specifies an area and transmits a request, the request is broadcast and distributed to a plurality of other vehicles, and vehicles present in the specified area transmit sensed data to the request source. Accordingly, data sensed in the specified area can be effectively utilized.

### SUMMARY OF THE INVENTION

Meanwhile, when collecting data sensed by a plurality of vehicles, completeness of information becomes a problem. For example, when sensing is carried out by a plurality of vehicles, areas where a sufficient amount of information can be acquired and areas where a sufficient amount of information cannot be acquired are created depending on density of the vehicles

However, having a larger number of vehicles transmit data in an attempt to increase coverage of information causes an excessive amount of information to be transmitted in areas where the density of vehicles is sufficiently high and, as a result, a network or a server is subjected to an unduly high load.

In order to solve this problem, vehicles to sense information in a specified area must be appropriately selected.

The present invention has been made in consideration of the problem described above and an object thereof is to appropriately select a subset of mobile sensors (e.g., vehicles with on-board sensors) in an apparatus which collect data sensed by a plurality of mobile sensors.

The present invention in its one aspect provides an information collection apparatus collecting data sensed by a plurality of mobile sensors, the information collection apparatus comprising a condition setting unit configured to set a target area and a target time period in which data is to be collected; a position information storage unit configured to acquire and store position information of the mobile sensors; a mobile sensor selection unit configured to select, based on the history of position information of the mobile sensors and the target time period, a plurality of the mobile sensors for collecting a given amount of data sensed in the target area; and a collection unit configured to collect data from the plurality of selected mobile sensors.

The condition setting unit is a unit configured to set an area (a target area) and a time period (a target time period) in which data is to be collected. The target area and the target time period may be specified by a user or may be specified by another apparatus and the like.

The mobile sensor selection unit analyzes the history of positions of mobile sensors during the target time period to select an appropriate subset of mobile sensors that can collect a given amount of data in the target area.

For example, when the past position information of mobile sensors is available and a past time period is specified as the target time period, mobile sensors having passed through the target area during the target time period can be identified. In this case, the collection unit can be configured to request the identified mobile sensors to send sensed data.

In addition, when the target time period is a time period no earlier than the current time, mobile sensors to pass through the target area during the time period can be predicted based on the history of position information. In this case, the collection unit can be configured to request mobile sensors to send data sensed when passing through the target area.

According to these configurations, by selecting only a subset of mobile sensors based on the history of their position information, redundant data communication and data processing can be mitigated as compared to the case where mobile sensors participating in sensing are randomly selected.

Note that “a given amount of data in the target area” does not necessary mean a total amount of data collected from the entire target region. For example, a certain geographical region may need more data than another region, even if these two regions are geographically close.

In this case, “a given amount of data in the target area” is considered to be collected when the required amount of data is collected for each of these sub-regions.

Also, the mobile sensor selection unit may be configured to preferentially select the mobile sensor that can perform sensing at more locations or times.

An example configuration is to give higher priority to mobile sensors that can measure wider geographical region and/or those that can observe sensor data of interest more frequently.

Accordingly, the number of mobile sensors to be selected and cost of data collection can be reduced without degrading the coverage and accuracy of sensing.

Also, the condition setting unit may be configured to further set, with respect to each of a plurality of segments constituting the target area, a necessary number of mobile sensors, which is the number of mobile sensors necessary for collecting the data, and the mobile sensor selection unit may be configured to determine that the given amount of data sensed in the target area can be collected when at least the necessary number of mobile sensors respectively belong the plurality of segments.

In this manner, the target area may be divided into multiple segments to require different number of mobile sensors to collect sensor data in each of these segments. For example, segments may be defined by a set of equal-sized grid cells, or by roads divided into equal length.

Specifying different number of mobile sensors for each segment allows, for example, to collect small amount of sensor data from less congested roads while collecting larger amount of data from busy roads.

Also, the mobile sensor selection unit may be configured to further divide the segments into a plurality of time slots, and when the necessary number or more mobile sensors respectively belong to all time slots corresponding to the target time period of all segments constituting the target area, determines that the given amount of data sensed in the target area can be collected.

By defining time slots followed by checking no less than the designated number of mobile sensors collect data in all the segments at all the time slots, both spatial and temporal coverage can be guaranteed.

Also, the necessary number of mobile sensors may be set based on the size of a corresponding segment. This is because larger geographical regions usually require larger number of vehicles to collect sufficient coverage of data collection.

Also, the mobile sensor selection unit may be configured to determine, when the designated target time period is a past time period, whether or not the given amount of data sensed in the target area can be collected by referring to past position information of the mobile sensors stored in the position information storage unit, and the collection unit may be configured to collect past data stored by the mobile sensors.

As described above, by having mobile sensors temporarily store sensed data and enabling the information collection apparatus to acquire past position information of the mobile sensors, data in a past time period can be collected.

The information collection apparatus may further comprises a position prediction unit configured to predict future position information of the mobile sensors and the mobile sensor selection unit may be configured to determine, when the designated target time period is a future time period, whether or not the given amount of data sensed in the target area can be collected based on the predicted position information of the mobile sensors, and the collection unit may be configured to collect data sensed by the mobile sensors in the future time period.

Conversely, by predicting position information of mobile sensors in the future, data in a future time period can be collected. For example, future position information may be predicted based on past position information or may be predicted based on route information acquired from the mobile sensors themselves or any other information source.

The present invention in its another aspect provides an information collection system comprising a plurality of mobile sensors and an information collection apparatus, wherein the mobile sensors include a sensing unit configured to sense data; and a position information transmission unit configured to periodically transmit position information to the information collection apparatus, and the information collection apparatus includes a condition setting unit configured to set a target area and a target time period in which data is to be collected; a position information storage unit configured to store position information acquired from the mobile sensors; a mobile sensor selection unit configured to select, based on the history of position information of the mobile sensors and the target time period, a plurality of the mobile sensors for collecting a given amount of data sensed in the target area; and a collection unit configured to collect data from the plurality of selected mobile sensors.

As described above, the present invention can also be specified as a system constituting mobile sensors and an information collection apparatus.

Also, the mobile sensors may be configured to search a vicinity for secondary mobile sensors, which are capable of communicating with the mobile sensors, and which include the sensing unit, and may relay data sensed by the secondary mobile sensors to the information collection apparatus, when a sufficient number of the mobile sensors for collecting the given amount of data sensed in the target area is not present.

Although mobile sensors (for example, vehicles) according to the present invention are configured to be capable of communicating with an information collection apparatus, there maybe cases where a predetermined amount of data cannot be collected by mobile sensors present in the target area. In such a case, mobile sensors search for secondary mobile sensors (mobile sensors which have only sensing functionality and the capability to communicate with other mobile sensors) around the mobile sensors and relay data. For example, the secondary mobile sensors may be vehicles having a vehicle-to-vehicle communication function. According to this configuration, a predetermined amount of data can be collected even when there are only a few mobile sensors that are capable of directly communicating with the information collection apparatus.

Moreover, the present invention can be specified as an information collection apparatus (an information collection system) which includes at least a part of the units described above. In addition, the present invention can also be specified as an information collection method carried out by the information collection apparatus (the information collection system). The processes and units described above may be implemented in any combination thereof insofar as technical contradictions do not arise.

According to the present invention, target mobile sensors can be appropriately selected in an apparatus which collects data sensed by a plurality of mobile sensors.

### BRIEF DESCRIPTION OF THE DRAWINGS

FIG. 1 is a schematic view of an information collection system according to a first embodiment;

FIG. 2 is a system configuration diagram of the information collection system according to the first embodiment;

FIGS. 3A and 3B are diagrams for explaining a correspondence between roads traveled by vehicles and segments;

FIG. 4 is a diagram showing a flow of data in the first embodiment;

FIG. 5 is a flow chart of processes performed by an information collection apparatus in the first embodiment;

FIG. 6 is a diagram for explaining a relationship between time slots and segments;

FIG. 7 is a flow chart of processes performed by the information collection apparatus in the first embodiment; and

FIG. 8 is a diagram showing a flow of data in a second embodiment.

### DESCRIPTION OF THE EMBODIMENTS

### First Embodiment

<Outline of System>

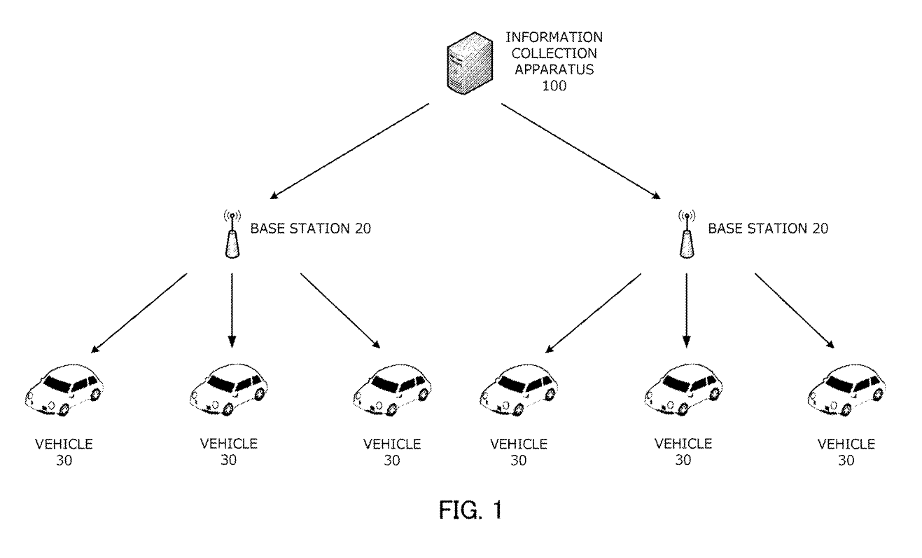

An outline of an information collection system according to a first embodiment will be described with reference to FIG. 1

The information collection system according to the first embodiment a system in which an information collection apparatus 100 and vehicles 30 communicate via base stations 20 and data sensed by the vehicles 30 is collected by the information collection apparatus 100. Note that the base stations 20 will be omitted in the following description.

The vehicles 30 according to the present embodiment are configured to be capable of collecting data using a sensing unit included in a vehicle-mounted terminal. For example, data may be related to a behavior of the vehicles or related to a surrounding environment of the vehicles. In addition, data need not necessarily be a numerical value. For example, data may be an image or a sound.

For example, when desiring to generate traffic congestion information based on data sensed in a certain area, a speed of each vehicle may conceivably be acquired and analyzed.

When a user issues an instruction to the information collection apparatus 100 to collect data sensed in a specific area, the information collection apparatus 100 issues a data transmission request to vehicles 30 corresponding to the specified area and the vehicles 30 transmit sensed data to the information collection apparatus 100.

On the other hand, several problems occur in such systems.

One of the problems is that collecting data from all of the vehicles present in the specified area results in an excessive amount of data communications.

Methods of solving this problem include a method involving setting uniform conditions and having only vehicles satisfying the conditions transmit data. For example, in a possible method, data is only transmitted by vehicles of which vehicle-mounted devices have a serial number with an even last digit.

However, using this method gives rise to another problem.

Since the vehicles 30 are ordinary consumer that travel on roads in an arbitrary manner, vehicle density may be non-uniform across the target area. For example, it may happen that a large number of vehicles concentrate on highways while only a small number of vehicles are distributed across residential areas. Therefore, setting uniform conditions for all vehicles present in the specified area ends up creating regions where an excessive amount of data is generated and regions with a shortage of data.

In order to solve this problem, in the information collection system according to the first embodiment, the information collection apparatus 100 collects and stores position information from the vehicles 30 and, selects a subset of vehicles to collect data to collect data only from the selected vehicles.

Hereinafter, the on-board unit mounted to the vehicles 30 will be referred to as a vehicle-mounted terminal 300.

<System Configuration>

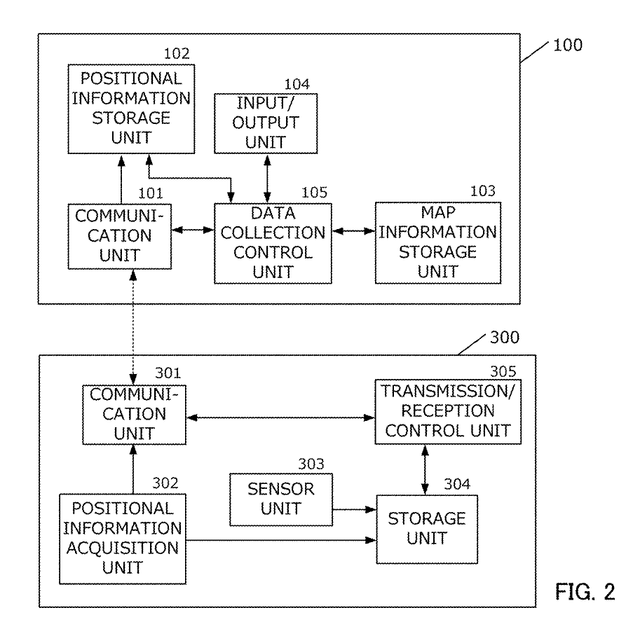

Hereinafter, a configuration of an information collection system for solving the problems described above will be described with reference to FIG. 2 which is a system configuration diagram.

The information collection apparatus 100 is a server apparatus which, based on an instruction from the user, collects data generated in a specified area in a specified time period from the vehicles 30 (the vehicle-mounted terminals 300) and presents the collected data to the user. Moreover, in the following description, it is assumed that data to be collected is sensor information collected by the vehicle-mounted terminals 300.

The information collection apparatus 100 is configured so as to include a communication unit 101, a position information storage unit 102, a map information storage unit 103, an input/output unit 104, and a data collection control unit 105.

The communication unit 101 is a unit that communicates with the vehicle-mounted terminal 300 by accessing a network via a communication link. The communication unit 101 is capable of communicating with the vehicle-mounted terminal 300 positioned at an arbitrary location using existing communication infrastructure such as a cellular communication network.

The position information storage unit 102 is a unit that collects and stores position information transmitted from the vehicle-mounted terminal 300. In the present embodiment, the vehicle-mounted terminal 300 periodically transmits its own position information (latitude and longitude) to the information collection apparatus 100 and the position information storage unit 102 stores the position information in association with an identifier of the vehicle-mounted terminal and date/time information.

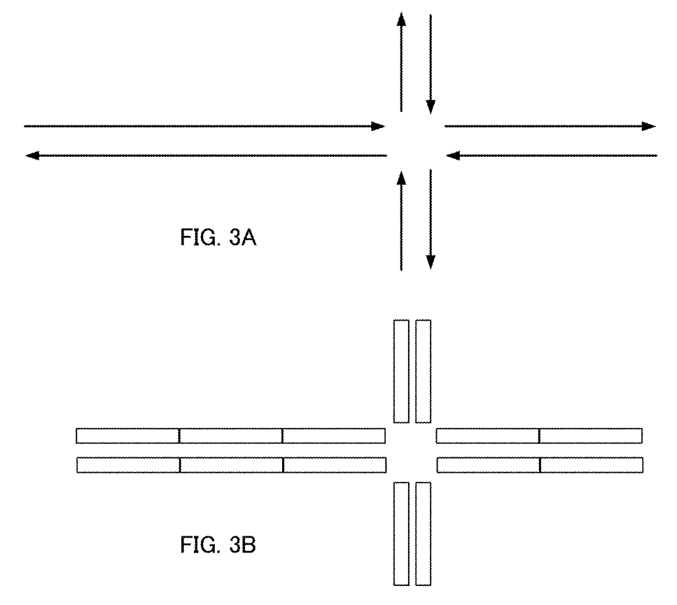

The map information storage unit 103 is a unit that stores information (hereinafter, map information) regarding areas which can be traveled by the vehicle 30. A management method of areas according to the present system will now be described with reference to FIGS. 3A and 3B. FIG. 3A is a diagram simulating roads traveled by the vehicles 30. The present example indicates a location where two two-lane roads intersect each other.

FIG. 3B represents an example of information stored in the map information storage unit 103. In the present system, road information is managed using a plurality of segments obtained by dividing a road into lanes and partitioning the divided lanes into prescribed lengths. In the example shown in FIG. 3B, a periphery of an intersection is divided into 14 segments. Geographical position information (for example, latitude and longitude) is associated with each segment. Accordingly, when a certain area is specified, segments included in the area can be specified.

The input/output unit 104 is a unit that performs input/output to/from the information collection apparatus 100. In the present embodiment, the input/output unit 104 executes: (1) a function for acquiring, from the user, conditions for collecting sensor information (hereinafter, collection conditions: specifically, a target area and a target time period in which collection is to be performed); and (2) a function for providing the user with sensor information collected by the vehicle-mounted terminals 300.

Moreover, the input/output unit 104 may provide the user with raw collected sensor information or processed data. For example, a function for generating traffic congestion information based on collected vehicle speed information may be executed. In addition, an input/output destination of data need not necessarily be the user. For example, input/output may be performed with respect to an application program, a driving support apparatus, or the like.

In addition, a time period included in the collection conditions may be a past time period or a future time period. In the present system, since the vehicle-mounted terminal 300 temporarily stores information collected by the vehicle-mounted terminal 300, past information can also be collected.

The data collection control unit 105 is a unit responsible for processes performed by the information collection apparatus 100 in general. Specifically, the data collection control unit 105 executes: (1) a function for acquiring collection conditions (an area and a time period); (2) a function for referring to position information stored in the position information storage unit 102 and map information stored in the map information storage unit 103, and selecting the vehicles 30 (the vehicle-mounted terminals 300) matching the acquired collection conditions; (3) a function for requesting the selected vehicles 30 (the vehicle-mounted terminals 300) for sensor information; and (4) a function for providing the user with sensor information transmitted from the vehicle-mounted terminals 300. Specific contents of the processes will be described later.

Next, the vehicle-mounted terminal 300 will be described.

The vehicle-mounted terminal 300 is configured so as to include a communication unit 301, a position information acquisition unit 302, a sensor unit 303, a storage unit 304, and a transmission/reception control unit 305.

The communication unit 301 is a unit that communicates with the information collection apparatus 100 by accessing a network via a communication link. Since functions thereof are similar to those of the communication unit 101, a detailed description will be omitted.

The position information acquisition unit 302 is a unit that acquires position information (latitude and longitude) of the vehicle-mounted terminal 300 and date/time information from a OPS module (not shown) provided in the apparatus. The position information and the date/time information acquired by the position information acquisition unit 302 are periodically transmitted via a communication link to the information collection apparatus 100 together with an identifier of the vehicle-mounted terminal.

The sensor unit 303 is a unit which includes a plurality of sensors mounted on the vehicle and which acquires sensor information using the sensors. For example, the sensor unit 303 may include a speed sensor, an acceleration sensor, a yaw rate sensor, a steering angle sensor, a radar, and a camera. Moreover, sensor information may be information obtained by sensing the entire vehicle or information obtained by sensing a periphery of the vehicle. For example, sensor information may be information regarding speed, acceleration, a steering angle, a yaw rate, an amount of precipitation, an obstacle, or the like. In addition, sensor information need not necessarily represent a physical quantity. For example, an image itself may be handled as sensor information. In addition, sensor information may not necessarily be raw data. For example, sensor information may be the number of pedestrians obtained by an image-based analysis.

The sensor information acquired by the sensor unit 303 is associated with the position information and the date/time information acquired by the position information acquisition unit 302 and stored in the storage unit 304 (to be described later).

The storage unit 304 is a unit that temporarily stores sensor information, position information, and date/time information. The storage unit 304 temporarily stores collected information until a request is issued from the information collection apparatus 100. The data may be stored for a designated period of time (e.g., one day, one week, etc.), or be kept for unlimited time unless the capacity of data storage is reached. These periods may be appropriately specified as part of system configuration.

The storage unit 304 includes a unit that temporarily or permanently stores data to be used by the apparatus. For example, a large-capacity storage medium capable of read/write at high speed such as a flash memory is favorably used.

The transmission/reception control unit 305 is a unit responsible for processes performed by the vehicle-mounted terminal 300 in general. Specifically, the transmission/reception control unit 305 performs: (1) a process for collecting position information and date/time information using the position information acquisition unit 302 and periodically transmitting the collected information to the information collection apparatus 100; and (2) a process for respectively acquiring sensor information from the sensor unit 303 and position information from the position information acquisition unit 302 and having the storage unit 304 store the acquired information. In addition, the transmission/reception control unit 305 performs: (3) a process for extracting and transmitting stored sensor information in response to a request transmitted from the information collection apparatus 100.

<Flow of Processes>

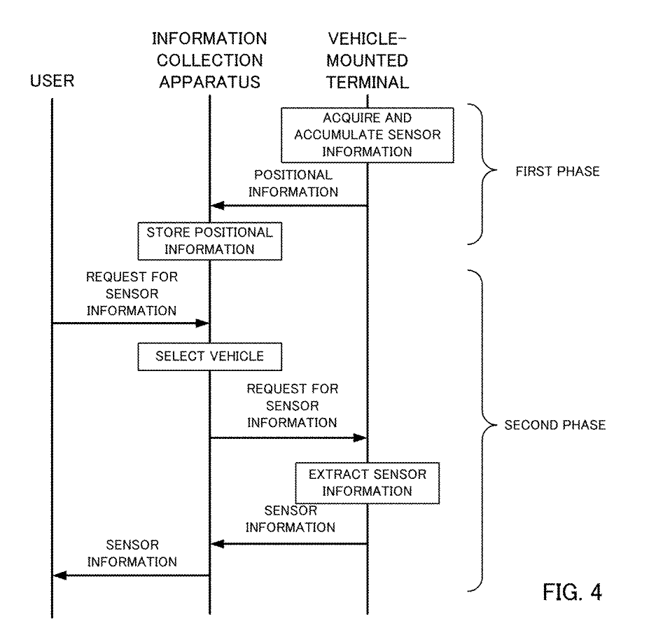

Next, a flow of processes performed by the present system will be described. FIG. 4 is a diagram for explaining a flow of processes among the user, the information collection apparatus 100, and the vehicle-mounted terminal 300.

First, the vehicle-mounted terminal 300 periodically acquires and stores sensor information. In doing so, the vehicle-mounted terminal 300 acquires position information representing a position at which the sensor information had been acquired and transmits the position information to the information collection apparatus 100. In addition, the information collection apparatus 100 stores the received position information in association with an identifier of the vehicle-mounted terminal. These processes are periodically performed by each vehicle. The processes described above will be referred to as the first phase.

When the user issues a request to the information collection apparatus 100 for sensor information, the information collection apparatus 100 refers to the stored position information and selects a target vehicle (vehicle-mounted terminal) to which sensor information is to be requested. The vehicle selected at this point is a vehicle having been traveling in a specified area in a specified time period (or a vehicle predicted to be traveling in the specified area in the specified time period).

Next, a request for sensor information is transmitted to the vehicle-mounted terminal 300 that is mounted to the corresponding vehicle and the transmitted sensor information is relayed. The processes described above will be referred to as the second phase.

Note that, in the present embodiment, it is assumed that one vehicle-mounted terminal is mounted to one vehicle. Therefore, in the following description, the selection of a vehicle is synonymous with the selection of a vehicle-mounted terminal.

<Flow Chart of Processes>

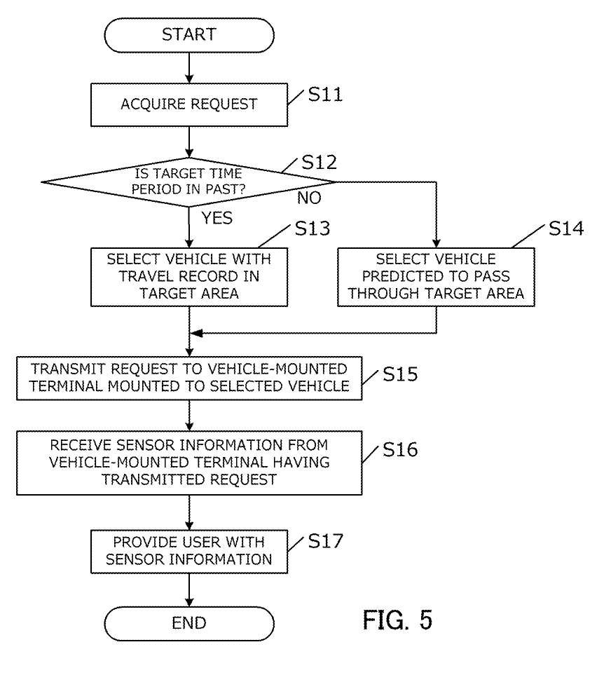

Next, processes performed in the second phase described above will be described in greater detail with reference to the flowchart in FIG. 5. It is assumed that, at the point where the processes shown in FIG. 5 starts, a sufficient amount of position information (past position information) of a plurality of vehicles 30 is stored in the position information storage unit 102.

Fist, in step S11, the input/output unit 104 acquires a request. The request may be directly input by the user or indirectly input via a network or the like. The request includes collection conditions (an area and a time period).

Next, in step 512, a determination is made on whether or not the target time period included in the collection conditions is a past time period. First, a case where a past time period is a target will be described.

When the target time period is a past time period, the data collection control unit 105 refers to position information stored in the position information storage unit 102 and maps stored in the map information storage unit 103, and selects a vehicle with a record of travel in the target area (a segment included in the target area) in the target time period.

A vehicle selection method in step 513 will be described below.

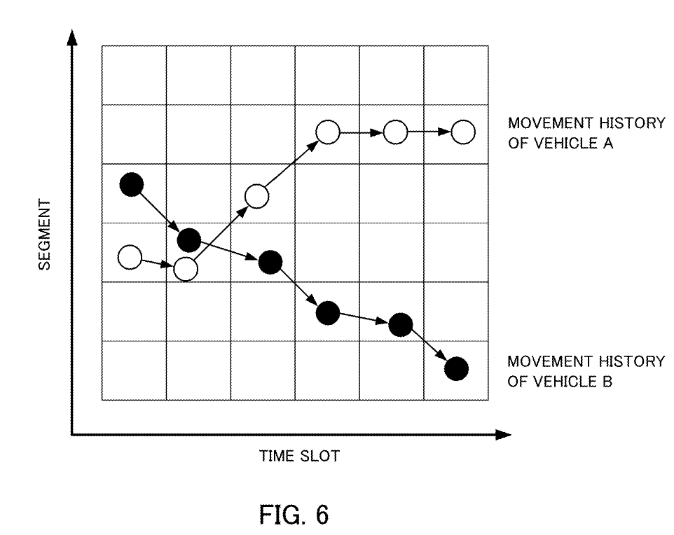

FIG. 6 is a diagram representing movement of a plurality of vehicles 30. In the diagram, a vertical axis represents a plurality of segments and a horizontal axis represents a plurality of time slots. Moreover, time slots refer to a div division of a time period into a plurality of slots and can be, for example, every 10 minutes. In addition, segments are the segments described earlier with reference to FIGS. 3A and 3B. The example shown in FIG. 6 represents the fact that the time period included in the collection conditions is constituted by six time slots and six segments. In step S13, a combination of vehicles is selected such that the designated number of vehicles are present for all time slots and all segments.

Let vⱼ denote the minimum number of vehicles necessary for collecting sensor information in a certain segment j. In other words, in step S13, a set of vehicles are selected such that at least vⱼ vehicles are present for all time slots and all segments.

In this manner, in step S13, a geographical distribution of the number of vehicles necessary for collecting sensor information in the target area is either acquired or generated, and vehicles are selected so as to satisfy the distribution.

Next, several algorithms for selecting a combination of a plurality of vehicles will be exemplified. Note that, in the following description, coverage is defined by the ratio of the number of selected vehicles over the sum of designated number of vehicles for all the segments and time slots. In other words, coverage of 1.0 means that vⱼ-number of vehicles are successfully selected for all segments and all time slots. Moreover, a value of vⱼ may be set based on the size of a segment For example, a larger number of vehicles may be selected as the number of lanes included in a segment increases or a length of the segment increases. In addition, the value of vⱼ may be specified by the user or may be automatically determined by the apparatus. Furthermore, the value of vⱼ may be stored in advance in association with a map.

(1) Brute Force Search

The brute force search method first extracts all the vehicles located in the target area during the target time period, and then generates all the possible subsets of the extracted vehicles. For each of the subsets, the algorithm checks if at least vⱼ vehicles exist in all the segments at all the time slots. In addition, when subsets of vehicles satisfying the requirements are specified, a request is sent to the vehicles included in a subset with the smallest number of vehicles.

Although the algorithm of the brute force search method is simple, computational overhead may increase exponentially as the number of vehicles increases. Therefore, a heuristic selection algorithm may be utilized in order to suppress the computational overhead.

(2) Greedy Method

The greedy method sequentially selects a vehicle that brings the largest increment to the coverage, which gradually increases as more vehicles are selected.

Given a set I′ of vehicles that are already selected by the algorithm, the coverage can be defined by the following formula. In the following expression, S denotes a set of segments and T denotes a set of time slots. In addition, vⱼ denotes the minimum number of vehicles that are required to collect sensor data in a segment j.

Furthermore, pᵢ (j, t) denotes a function representing a probability that a vehicle i is present in the segment j in a time slot t. In the present example where a past time period is specified as a target, pᵢ (j, t) takes a value of 0 or 1. Specifically, pᵢ (j, t) becomes 1 if the vehicle i was in the segment j at the time slot 1, or 0 otherwise.

Coverage(I′)=Σ_{j∈S,t∈T}min(1.0, Σ_{i∈I′}pᵢ(j,t)/vⱼ)/(|S|×|T|) [Math. 1]

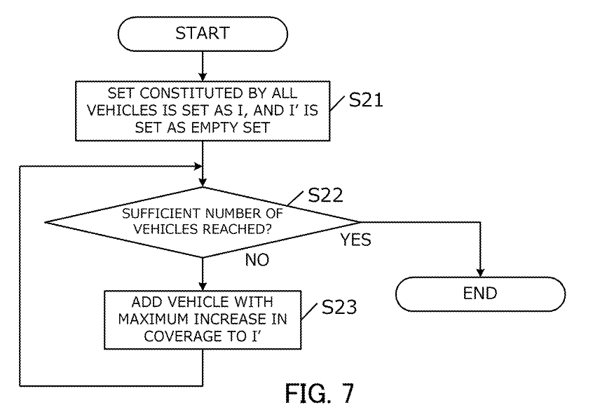

In the greedy method, vehicles are sequential selected starting with a vehicle that brings the largest increment to coverage, and the process for selecting vehicles is repeated until the coverage reaches 1.0 or all vehicles are selected. FIG. 7 is a diagram showing an algorithm of the greedy method in the form of a flow chart.

First, in step S21, the set I is initialized by a set of all the vehicles, while I′ is initialized by an empty set.

The step S22 determines whether or not a sufficient number of vehicles is already selected (in other words, whether coverage has reached 1.0 or whether all vehicles have been selected). If not, the process goes to step S23 to select a new vehicle that brings the largest increment to coverage from I and add the selected vehicle to I′, By repeating this process, a plurality of vehicles to collect sensor information can be selected.

A vehicle that brings the largest increment to coverage usually belongs to larger number of segments and time slots. In other words, by preferentially selecting vehicles with the large increment on coverage, vehicles capable of sensing a larger amount of sensor information can be preferentially selected. In other words, the number of vehicles to be selected can be kept to the minimum.

Returning to FIG. 5, the description will be continued.

In step S15, a request for sensor information is transmitted to vehicle-mounted terminals mounted to the selected vehicles. When the vehicle-mounted terminal 300 (the transmission/reception control unit 305) receives the request, sensor information conforming to the collection conditions (an area and a time period) included in the request is acquired from the storage unit 304 and transmitted to the information collection apparatus 100 Sensor information transmitted from a plurality of vehicles is collected by the information collection apparatus 100 (step 516) and provided to the user (step S17).

In step S12, when the target time period is in the future, the process makes a transition to step S14. When the target time period is in the future, vehicles must be selected based on their prediction paths over the designated time period. Therefore, in step S14, based on position information stored in the position information storage unit 102, a future position of each vehicle is estimated and vehicles are selected using the estimated positions. For example, a probability that a vehicle i is present in a segment j in a time slot t can be calculated and vehicles can be selected according to the greedy method using the mathematical expression described earlier.

Position estimation of a vehicle can be performed using well known techniques. For example, vehicle paths may be predicted based on a traffic flow model that is generated by way of road traffic simulations or analysis of real vehicle probe data sets.

The future position of a vehicle may be also estimated by other means. For example, when planned route information or information regarding a destination can be obtained from vehicles, such information may be additionally stored in the position information storage unit 102. In addition, when a target vehicle is a public transportation vehicle, an estimate may be made based on operation information and the like.

When the target time period is in the future, the vehicle-mounted terminal 300 starts collecting sensor information at the specified time, and then transmits the collected sensor information to the information collection apparatus 100.

According to the first embodiment, with respect to an area and a time period specified by a user, a plurality of vehicles for collecting a necessary and sufficient amount of sensor information can be selected. Accordingly, the number of vehicles can be varied for each segment and desired data can be obtained from the minimum amount of vehicles. In particular, by selecting a small subset of vehicles based on their historical or predicted paths, redundant data collection can be suppressed.

### Second Embodiment

In the first embodiment, the vehicle-mounted terminal 300 directly communicates with the information collection apparatus 100. However, some vehicles may not have access to the information collection apparatus 100 via network infrastructure. On the other hand, an increasing number of vehicles are equipped with the vehicle-to-vehicle communications functionality. The second embodiment enables a vehicle that has only the vehicle-to-vehicle communications capability to participate in the information collection to extend the first embodiment.

In the second embodiment, a vehicle-mounted terminal having a function for directly communicating with the information collection apparatus 100 will be referred to as a dedicated vehicle-mounted terminal and a vehicle-mounted terminal only having a function for communicating with other vehicles will be referred to as a general-purpose vehicle-mounted terminal. A general-purpose vehicle-mounted terminal has similar functions to the vehicle-mounted terminal 300 shown in FIG. 2 except that it cannot directly access the information collection apparatus via network infrastructure.

In the second embodiment, as in step S13, the system first attempts to achieve the coverage of 1.0 by selecting only vehicles with a dedicated vehicle-mounted terminal. When the coverage is insufficient (i.e., the coverage does not reach 1.0 even if all possible vehicles are selected), the dedicated vehicle-mounted terminal is requested to search for a general-purpose vehicle-mounted terminal in their vicinity.

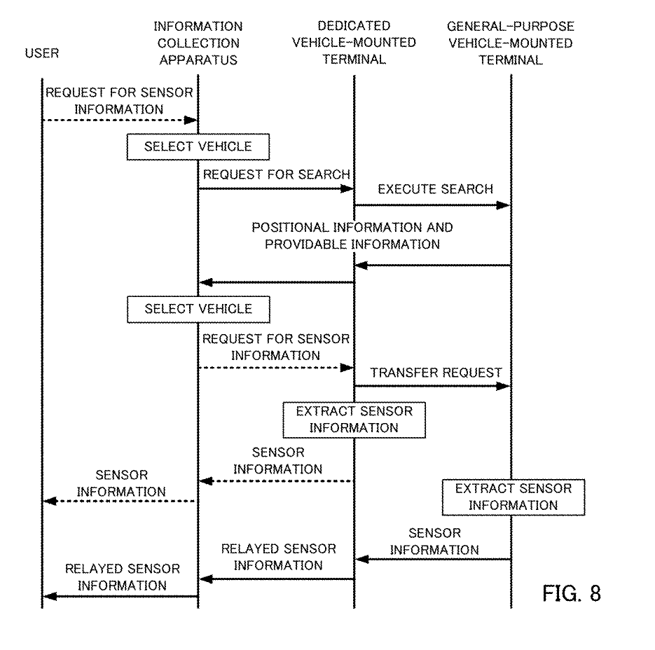

FIG. 8 is a diagram showing the second phase of the second embodiment. Dotted lines indicate the same processes as in the first embodiment.

In the second embodiment, in step S13, when it is determined that a dedicated vehicle-mounted terminal alone cannot provide sufficient coverage, the dedicated vehicle-mounted terminal is requested to search for a general-purpose vehicle-mounted terminal in their vicinity. Using vehicle-to-vehicle communication, the dedicated vehicle-mounted terminal having received the request searches for a general-purpose vehicle-mounted terminal positioned in a periphery of its own vehicle and, in response thereto, the general-purpose vehicle-mounted terminal notifies position information of its own vehicle and types of information it can provide. Moreover, when the general-purpose vehicle-mounted terminal has past position information and information regarding a future movement path, the general-purpose vehicle-mounted terminal can transmit the path along with the response message. The notified information is transferred to the information collection apparatus and, using the information, the information collection apparatus re-computes coverage and selects vehicles. Moreover, while step S13 is described in the present example, a similar process is performed in step S14.

In addition, in the second embodiment, in step S15, a request to a general-purpose vehicle-mounted terminal is included in the request to be transmitted to the dedicated vehicle-mounted terminal. When the dedicated vehicle-mounted terminal receives the request, the request is transferred to the general-purpose vehicle-mounted terminal and, in response thereto, the general-purpose vehicle-mounted terminal transmits sensor information. The sensor information transmitted from the general-purpose vehicle-mounted terminal is transferred by the dedicated vehicle-mounted terminal and reaches the information collection apparatus 100.

As described above, in the second embodiment, since sensor information is collected by also using vehicle-mounted terminals only equipped with a vehicle-to-vehicle communication function, sensor information can be collected from a larger number of vehicles.

(Modification)

The embodiments described above merely represent examples and the present invention can be implemented with various modifications without departing from the spirit and scope of the invention.

For example, while a target area is divided into segments and time slots in the description of the embodiments, a target area may be divided into only either segments or time slots.

In addition, while a vehicle is selected with a specified time period as a target in the description of the embodiments, there is a risk that a sufficient number of vehicles cannot be selected if the time period is long. In consideration thereof, when coverage is insufficient, a time period may be automatically divided and processes may be performed with respect to each divided time period.

Furthermore, while a general-purpose vehicle-mounted terminal transmits sensor information using vehicle-to-vehicle communication in the second embodiment, communication methods other than vehicle-to-vehicle communication may be used to transmit uplink data. Examples include roadside units, public Wi-Fi access points, and the like.

What is claimed is:

1. An information collection apparatus collecting data sensed by a plurality of mobile sensors, the information collection apparatus comprising:
a condition setting unit configured to set a target area and a target time period in which data is to be collected;
a position information storage unit configured to acquire and store position information of the mobile sensors;
a mobile sensor selection unit configured to select, based on the history of position information of the mobile sensors and the target time period, a plurality of the mobile sensors for collecting a given amount of data sensed in the target area; and
a collection unit configured to collect data from the plurality of selected mobile sensors.

2. The information collection apparatus according to claim 1, wherein
the mobile sensor selection unit is configured to preferentially select the mobile sensor that can perform sensing at more locations or times.

3. The information collection apparatus according to claim 1, wherein
the condition setting unit is configured to further set, with respect to each of a plurality of segments constituting the target area, a necessary number of mobile sensors, which is the number of mobile sensors necessary for collecting the data, and
the mobile sensor selection unit is configured to determine that the given amount of data sensed in the target area can be collected when at least the necessary number of mobile sensors respectively belong to the plurality of segments.

4. The information collection apparatus according to claim 3, wherein
the mobile sensor selection unit is configured to further divide the segments into a plurality of time slots, and
when the necessary number or more mobile sensors respectively belong to all time slots corresponding to the target time period of all segments constituting the target area, determines that the given amount of data sensed in the target area can be collected.

5. The information collection apparatus according to claim 3, wherein
the necessary number of mobile sensors is set based on the size of a corresponding segment.

6. The information collection apparatus according to claim 1, wherein
the mobile sensor selection unit is configured to determine, when the designated target time period is a past time period, whether or not the given amount of data sensed in the target area can be collected by referring to past position information of the mobile sensors stored in the position information storage unit, and
the collection unit is configured to collect past data stored by the mobile sensors.

7. The information collection apparatus according to claim 1, further comprising
a position prediction unit configured to predict future position information of the mobile sensors, wherein
the mobile sensor selection unit is configured to determine, when the designated target time period is a future time period, whether or not the given amount of data sensed in the target area can be collected based on the predicted position information of the mobile sensors, and
the collection unit is configured to collect data sensed by the mobile sensors in the future time period.

8. An information collection system comprising a plurality of mobile sensors and an information collection apparatus, wherein
the mobile sensors include
a sensing unit configured to sense data; and
a position information transmission unit configured to periodically transmit position information to the information collection apparatus, and
the information collection apparatus includes:
a condition setting unit configured to set a target area and a target time period in which data is to be collected;
a position information storage unit configured to store position information acquired from the mobile sensors;
a mobile sensor selection unit configured to select, based on the history of position information of the mobile sensors and the target time period, a plurality of the mobile sensors for collecting a given amount of data sensed in the target area; and
a collection unit configured to collect data from the plurality of selected mobile sensors.

9. The information collection system according to claim 8, wherein
the mobile sensor selection unit is configured to preferentially select the mobile sensor that can perform sensing at more locations or times.

10. The information collection system according to claim 8, wherein
the condition setting unit is configured to further set, with respect to each of a plurality of segments constituting the target area, a necessary number of mobile sensors, which is the number of mobile sensors necessary for collecting the data, and
the mobile sensor selection unit is configured to determine that the given amount of data sensed in the target area can be collected when at least the necessary number of mobile sensors respectively belong to the plurality of segments.

11. The information collection system according to claim 10, wherein
the mobile sensor selection unit is configured to further divide the segments into a plurality of time slots, and
when the necessary number or more mobile sensors respectively belong to all time slots corresponding to the target time period of all segments constituting the target area, determines that the given amount of data sensed in the target area can be collected.

12. The information collection system according to claim 10, wherein
the necessary number of mobile sensors is set based on the size of a corresponding segment.

13. The information collection system according to claim 8, wherein
the mobile sensors further include data storage units configured to store sensed data, and
the mobile sensor selection unit included in the information collection apparatus is configured to determine, when the designated target time period is a past time period, whether or not the given amount of data sensed in the target area can be collected by referring to past position information of the mobile sensors that is kept in the position information storage unit, and
the collection unit is configured to collect past data stored by the mobile sensors.

14. The information collection system according to claim 8, wherein
the information collection apparatus further includes a position prediction unit configured to predict future position information of the mobile sensors,
the mobile sensor selection unit included in the information collection apparatus is configured to determine, when the designated target time period is a future time period, whether or not the given amount of data sensed in the target area can be collected based on the predicted position information of the mobile sensors, and
the collection unit is configured to collect data sensed by the mobile sensors in the future time period.

15. The information collection system according to claim 8, wherein
the mobile sensors are configured to search a vicinity for secondary mobile sensors, which are capable of communicating with the mobile sensors and which include the sensing unit, and relay data sensed by the secondary mobile sensors to the information collection apparatus, when a sufficient number of the mobile sensors for collecting the given amount of data sensed in the target area is not present.
